(19) United States
(12) Patent Application Publication
(10) Pub. No.: US 2010/0116894 A1
(43) Pub. Date: May 13, 2010

(54) Device for displaying the residual amount of rechargeable credit cards

(76) Inventor: Luigi Modica, Palermo (IT)

Correspondence Address: Themis Law, 7660 Fay Ave Ste H-535, La Jolla, CA, 92037, US

(21) Appl. No.: 12/593,978

(22) PCT Filed: Apr. 7, 2008
(86) PCT No.: PCT/IB08/51321

§ 371 Date: Oct. 5, 2009

(30) Foreign Application Priority Data
Apr. 6, 2007 (IT) PA2007A000012
Apr. 6, 2007 (IT) PA2007A000013
Apr. 6, 2007 (IT) PA2007A000014
Apr. 6, 2007 (IT) PA2007A000015

(51) Int. Cl. G06K 19/06; G09F 11/00; G09F 11/02; G09F 11/04

(52) U.S. Cl. 235/492; 40/446; 40/493

(57) ABSTRACT

A display device for prepaid credit cards includes a support surface associable with a credit card and means for indicating numerical data concerning the residual amount of the card, which are mounted onto the support surface. Such indication means are of mechanical type only. The support surface may consist of the outer wall of a credit card or a credit card case.

### FIELD OF THE INVENTION

The present invention finds application in the technical field of information displaying apparatus and particularly relates to a device for displaying the residual credit of a prepaid card.

The invention further relates to a credit card and a credit card case comprising such device.

### BACKGROUND ART

So-called “stored value” or “prepaid” credit cards, i.e. those that can be electronically loaded with a predetermined amount of money by the issuer to be used for payments or cash withdrawals, and which can be reloaded when the initial balance has been spent have been increasingly used in the past few years.

This type of credit card is mainly used for on-line purchases, in which the use of ordinary credit cards with no theoretical spending limit might involve the risk of fraudulent use thereof. Furthermore, credit cards of this type are typically employed by users who want to have a preset maximum spending limit or who are not bank account owners and cannot be granted traditional credit cards.

One drawback of these known credit cards is that they do not allow exact and constant determination of the residual amount available for transactions. This may result in the attempt to make purchases without having sufficient money available, or in unsuccessful telematic payment transactions.

In an attempt to overcome this drawback, a telematic computer system has been provided that can display the residual spendable amount on the card, subject to card identification by the use passwords or similar codes.

This known system suffers from the drawback that users can only retrieve the information they need if they have a computer or other computer means connected to the Internet at their disposal and cannot instantaneously and constantly check the residual spendable amount on the card, for instance while on journey or during shopping.

JP-A-9220889 discloses a credit card having a display for showing the residual spendable amount on the card. This data is automatically updated each time is used.

Nonetheless, this card has a very complex construction, due to the presence of delicate electronic display means, which are also easily exposed to damages caused by shocks or improper use.

### SUMMARY OF THE INVENTION

The object of this invention is to overcome the above drawbacks, by providing a device for displaying the residual amount of stored value credit cards that is highly efficient and relatively cost-effective.

A particular object is to provide a device that is simple and convenient to use.

A further object is to provide a device which minimizes fabrication times and costs.

Yet another object of the invention is to provide a device that ensured durability.

These and other objects, as better explained hereafter, are fulfilled by a device for displaying the balance of a credit card which, as defined in claim 1, comprises a support surface for association with a credit card and means for indicating numerical data concerning the residual amount, that are mounted to said support surface, wherein said indication means are of mechanical type only.

Thanks to this combination of characteristics, the device of the invention will be of particularly practical and simple use.

Furthermore, the device will have very low fabrication costs, such that the cost of the credit card with which it is associated is not substantially increased.

Advantageously, the mechanical indication means may include a plurality of indicating elements mounted to the support surface, for easier reading of the residual amount on the card.

Preferably, each of the indicating elements includes a sequence of digits in adjacent positions that can be aligned with display windows formed on the support surface.

Conveniently, each of the indicating elements may have drive means susceptible of being selectively driven by a user to align a digit of the indicating element with the display window therefor to form a total number equal to the residual amount of the card.

Advantageously, the device of the invention will be integrated in a credit card or in a holding case therefor.

The dependent claims disclose particularly advantageous embodiments of the invention.

### BRIEF DESCRIPTION OF THE DRAWINGS

Further features and advantages of the invention will become more apparent upon reading the following detailed description of a few preferred non exclusive embodiments of the display device of invention, which are described by way of non limiting example with the help of the accompanying drawings in which:

FIG. 1 is a perspective view of a first embodiment of the device of the invention;

FIG. 2 is a plan view of the device of FIG. 1, with a front covering layer partly removed therefrom;

FIG. 3 is a sectional view of the embodiment of FIG. 1, as taken along a plane III-III;

FIG. 4 is a perspective view of a second embodiment of the device of the invention;

FIG. 5 is a diagrammatic plan view of the device of FIG. 4, with a front covering layer partly removed therefrom;

FIG. 6 is a sectional view of the device of FIG. 5, as taken along a plane VI-VI.

### DETAILED DESCRIPTION OF PREFERRED EMBODIMENTS

Referring to the above figures, the display device of the invention, generally designated by numeral 1, may be used for displaying the residual amount of prepaid credit cards.

The device 1 essentially comprises a support surface 2 which can be associated with a credit card and indication means 3 for indicating numerical data concerning the residual amount of the card, which indication means are mounted to the support surface 2.

The support surface 2 may consist of the main wall of a credit card case, as shown in the annexed figures, or an outer surface of a credit card, not shown in the drawings.

While reference will be made hereinbelow to credit cards, it shall be understood that the device of the invention may be integrated in any case and/or stored value card, such as parking cards, cards containing predetermined amounts of money for buying gifts, newspapers, books, collectibles, clothes, accessories, discount cards of large chain stores, cards containing predetermined amounts of money to be used as a gift, which are issued by chain stores and any other type of stored value cards.

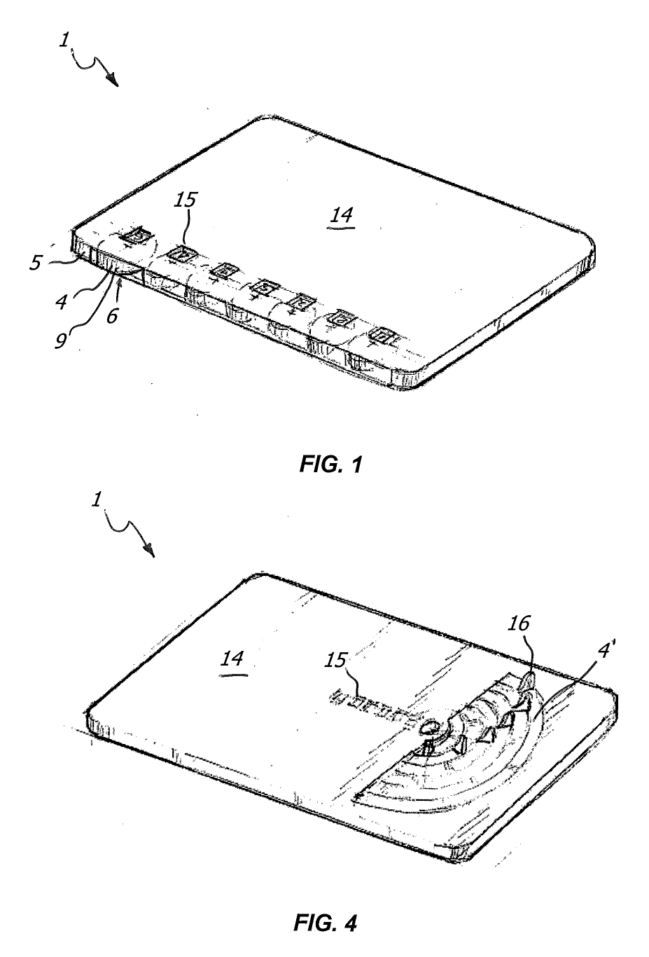

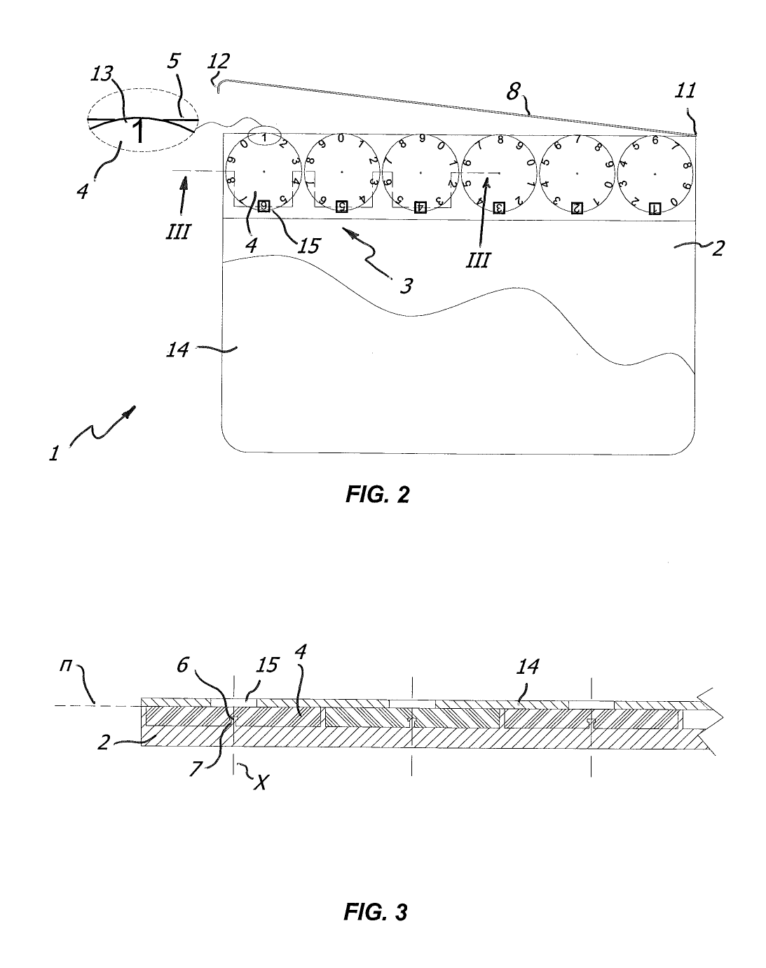

A first embodiment of the display device of the invention is shown in FIGS. 1 to 3. In this embodiment, the indication means 3 include a plurality of substantially planar and circular disk elements rotatably mounted to the support surface 2, with axes of rotation X arranged along a line parallel to a lateral edge 5 thereof.

Conveniently, the indicating elements 4 may be rotatably mounted to pins 6 that extend from the surface 2 along the axes X substantially perpendicular to the latter and fit in respective receptacles 7 formed on the bottom face of the disks 4.

Special passages 8 may be formed along the outer lateral edge 5 of the support surface 2, for the outer peripheral edges of the disk elements to slightly project therefrom to allow a user to contact and rotate them from the outside.

As particularly shown in FIG. 1, contact friction with the outer peripheral edges of the disk elements 4 may be increased by providing special knurlings 9 thereon,

A protection and locking bar 10 may be provided along the lateral edge 5, with one end 11 pivoting about the longitudinal end of the lateral edge 5 and the opposite end 12 being folded and shaped for snap engagement with the opposite end of the edge 5 in such a position as to lock the rotation of the disk elements 4.

Each disk element 4 is provided with a sequence of digits from 0 to 9 on its top face, in adjacent and angularly offset positions along an annulus 13. The digits may be evenly arranged along the whole circumferential extension of the annulus 13 or along a part thereof.

A covering layer 14 may be provided above the circular elements 4 facing towards the support surface 2, for protecting the indicating elements 4 and prevent damaging and undesired motion thereof. Such covering layer 14 may be printed with the logo of the issuer, the name of the holder, the card number, one or more advertising markings or other decorative elements.

An array of adjacent windows 15 may be formed on the covering layer 14, through which the digits printed or applied on the indicator disk elements 4 may be displayed.

In operation, the user may selectively operate each of the elements 4 to align the desired digits with the corresponding windows 15, until the number corresponding to the residual amount on the card is formed.

The disk elements 4 and the windows 5 may be provided in any number for displaying the amount as integers or decimals.

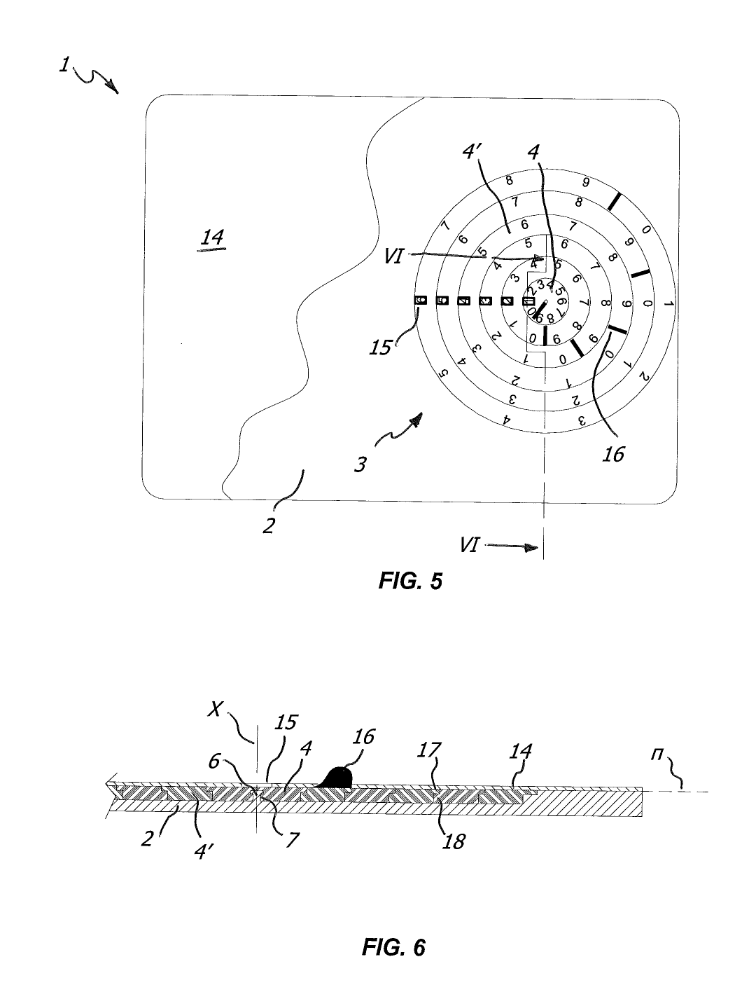

FIGS. 4 to 6 show a second embodiment, in which the indicating elements 4 are concentric and not offset.

Particularly, a minimum diameter disk 4 may be placed at the center and rotatably mounted to the support surface 2 to rotate about an axis X perpendicular to the support surface 2, a succession of circular ring elements 4′ with progressively increasing diameters being arranged concentric therewith. Each annular element has an inside diameter equal to the outside diameter of the adjacent element with a small clearance therebetween to allow independent rotation. Furthermore, each indicating element 4, 4′ may have a tongue 16 projecting from the side opposite the support surface 2 to allow manual drive thereof by a user.

A sequence of digits from 0 to 9 may be printed on the periphery of the indicating elements 4, 4, for forming the number that corresponds to the residual balance.

For the indicating elements 4, 4′ to be rotatably secured to the support surface 2, a pin 6 may be formed on the surface 2, which is designed to be fitted in a mating receptacle formed on the bottom face of the central disk element 4. The adjacent annular elements 4′ are retained by providing a peripheral step 17 on each of them, for an annular projection 18 of the adjacent element or disk to lie thereon.

Also in this embodiment a covering layer 14 is provided, with adjacent windows for the digits printed on the indicating elements 4, 4′ to be displayed therethrough.

In operation, the user may act on the tongues 16 to cause the number corresponding to the residual balance to appear through the windows 15, so that the value thereto may be instantaneously and constantly monitored.

The above disclosure shows that the device of the invention fulfills the intended objects and particularly meets the requirement of providing a device that is very simple and ready to use. The device so designed is also highly cost-effective and durable.

The device of this invention is susceptible to a number of changes and variants, all falling within the scope defined in the appended claims. All the details may be replaced by other technically equivalent elements, and the materials may be different depending on different needs.

While the device has been described with particular reference to the accompanying figures, the numerals referred to in the disclosure and claims are only used for the sake of a better intelligibility of the invention and shall not be intended to limit the claimed scope in any manner.

What is claimed is:

1. A display device for credit cards, comprising:
a support surface for association with a credit card; and
indication means for indicating numerical data concerning a residual amount of the card, said indication means being mounted onto said support surface,
wherein said indication means are of mechanical type only.

2. The device as claimed in claim 1, wherein said indication means include a plurality of indicating elements rotatably mounted onto said support surface, said indicating elements being configured to rotate about one or more axes substantially perpendicular thereto.

3. The device as claimed in claim 2, further comprising a covering layer couplable to said support surface, wherein each of said indicating elements includes a sequence of digits in adjacent positions, said digits being alignable with display windows formed in said covering layer.

4. The device as claimed in claim 3, wherein each of said indicating elements is configured to be selectively driven by a user such to align a digit thereof with at least one of said display windows to form a total number equal to the residual amount of the card.

5. The device as claimed in claim 2, wherein said indicating elements comprise a plurality of disk elements with axes in offset positions, evenly arranged along a line substantially parallel to a peripheral edge of said support surface.

6. The device as claimed in claim 5, wherein said peripheral edge has a plurality of passages or apertures for said indicator disk elements to project out of the peripheral edge.

7. The device as claimed in claim 5, further comprising a protection bar having a first end pivoting about a longitudinal end of said lateral edge and a second end designed for snap engagement with an end of said peripheral edge for locking a rotation of said disk elements.

8. The device as claimed in claim 5, wherein each of said disk elements has knurled edges along its periphery for facilitating contact and rotation thereof by a user.

9. The device as claimed in claim 2, wherein said indicating elements include a central disk element and a plurality of annular elements with progressively increasing diameters arranged externally to and concentrically with said central disk element.

10. A credit card comprising:
a support surface for association with the credit card; and
indication means for indicating numerical data concerning a residual amount of the card, said indication means being mounted onto said support surface,
wherein said indication means are of mechanical type only.

11. A credit card case comprising:
a support surface for association with a credit card; and
indication means for indicating numerical data concerning a residual amount of the card, said indication means being mounted onto said support surface,
wherein said indication means are of mechanical type only.

12. The credit card as claimed in claim 10, wherein said indication means include a plurality of indicating elements rotatably mounted onto said support surface, said indicating elements being configured to rotate about one or more axes substantially perpendicular thereto.

13. The credit card as claimed in claim 12, further comprising a covering layer couplable to said support surface, wherein each of said indicating elements includes a sequence of digits in adjacent positions, said digits being alignable with display windows formed in said covering layer.

14. The device as claimed in claim 13, wherein each of said indicating elements is configured to be selectively driven by a user such to align a digit thereof with at least one of said display windows to form a total number equal to the residual amount of the card.

15. The device as claimed in claim 12, wherein said indicating elements include a central disk element and a plurality of annular elements with progressively increasing diameters arranged externally to and concentrically with said central disk element.

16. The credit card case as claimed in claim 11, wherein said indication means include a plurality of indicating elements rotatably mounted onto said support surface, said indicating elements being configured to rotate about one or more axes substantially perpendicular thereto.

17. The credit card as claimed in claim 16, further comprising a covering layer couplable to said support surface, wherein each of said indicating elements includes a sequence of digits in adjacent positions, said digits being alignable with display windows formed in said covering layer.

18. The device as claimed in claim 17, wherein each of said indicating elements is configured to be selectively driven by a user such to align a digit thereof with at least one of said display windows to form a total number equal to the residual amount of the card.

19. The device as claimed in claim 16, wherein said indicating elements include a central disk element and a plurality of annular elements with progressively increasing diameters arranged externally to and concentrically with said central disk element.
